(19) United States
(12) Patent Application Publication
(10) Pub. No.: US 2005/0124476 A1
(43) Pub. Date: Jun. 9, 2005

(54) Multi-use film support apparatus

(76) Inventor: Luiz Antonio Kuhl, Sao Paulo (BR)

Correspondence Address: LaRiviere, Grubman & Payne, LLP, P.O. Box 3140, Monterey, CA, 93942, US

(21) Appl. No.: 10/925,893

(22) Filed: Aug. 24, 2004

(30) Foreign Application Priority Data
Aug. 25, 2003 (BR) 8302153-1

(51) Int. Cl. F16C 13/00

(52) U.S. Cl. 492/39

(57) ABSTRACT

The present invention provides for an apparatus which support multi-use film. The apparatus includes a first outer tube and second outer tube, each having a diameter and a length. An inner cylinder having a smaller diameter than the diameters of the first and second outer tubes allows the for the inner cylinder to be slidably inserted into the first outer tube and the second outer tube. The outer tube are secured to the inner cylinder via end covers. The outer tubes, due to the larger diameters, are able to rotate about the inner cylinder independent of the each other. The multi-use film is placed on one outer tube. The user holds the other outer tube to apply the multi-use film.

### REFERENCE TO PENDING APPLICATIONS

Under 35 U.S.C. §119, this application claims benefit of Brazilian Patent Application serial number no. 8302153-1 filed in the Brazilian Patent Office on 25 Aug. 2003 entitled DISPOSITION INTRODUCED IN ROLL FOR MULTI-USE FILM.

### REFERENCE TO MICROFICHE APPENDIX

This application is not referenced in any microfiche appendix.

### BACKGROUND OF THE INVENTION

1. Field of the Invention

The present invention relates to a support for multi-use film. More particularly, the present invention relates a support which utilizes interconnecting cylinders for the storage, packaging and application of multi-use film.

2. Background

Multi-use film, such as plastic wrapping film, can be utilized in various manners and with various items, including the protecting and packaging food and other objects, used in mechanical repair shops, dental offices, kitchens, and flower shops. The prior art supports for rolls of multi-use film are of a simple configuration, which consists of a slim and long cylinder rolled up by the plastic film. This configuration makes the application and/or using of the multi-use film to be difficult and not very practical. This is due to the user having to unroll the film prior to use while at the same time involving the object and/or food. This causes the multi-use film to often be wasted, be applied with wrinkles or placing it in a wrong direction.

Clearly there is a need for a support for multi-use film that can improve upon the prior art dentures.

### SUMMARY OF THE INVENTION

The present invention satisfies the needs discussed above. The present invention is generally directed toward a support for multi-use film. More particularly, the present invention relates a support which utilizes interconnecting cylinders for the storage, packaging and application of multi-use film.

One aspect of the present invention provides for an apparatus to support multi-use film. This apparatus includes two outer tubes, each having a diameter, first and second diameters, and a length and an inner cylinder having a third diameter and a third length. The third diameter of the inner cylinder is smaller than the diameters of the outer tubes, such that the inner cylinder can be slidably inserted into the outer tubes. This allows the outer tubes to independently rotate about the inner cylinder. The outer tubes are secured to the inner cylinder via end covers. The multi-use film is rolled up over the surface of one of the outer tubes. A user holds the other outer tube to apply the multi-use film, which allows the first outer tube to be able to spin freely about the inner cylinder.

Another aspect of the present invention provides for an apparatus to support multi-use film as set out above wherein the lengths of the first outer tube is either longer, shorter or equal to than the length of the second outer tube.

Another aspect of the present invention provides for an apparatus to support multi-use film as set out above wherein the length of the inner cylinder is longer than the length of the first outer tube and/or second outer tube.

Another aspect of the present invention provides for an apparatus to support multi-use film as set out above wherein first end cover is identical to the second end cover.

Still yet another aspect of the present invention provides for an apparatus to support multi-use film as set out above wherein the first diameter of the first outer tube is equal to the second diameter of the second outer tube.

Upon reading the above description, various alternative embodiments will become obvious to those skilled in the art. These embodiments are to be considered within the scope and spirit of the subject invention, which is only to be limited by the claims which follow and their equivalents.

### BRIEF DESCRIPTION OF THE DRAWINGS

FIG. 1 is a perspective view of an embodiment of the present invention.

FIG. 2 is an exploded side view of the embodiment of the present invention as set forth in FIG. 1.

FIG. 3 is a front view of the embodiment of the present invention as set forth in FIG. 1.

FIG. 4 is an end view of the embodiment of the present invention as set forth in FIG. 1.

FIG. 5 is a side view of the embodiment of the present invention as set forth in FIG. 1.

### DETAILED DESCRIPTION OF THE INVENTION

The attached drawings demonstrate an embodiment of the present invention. It is to be understood that the invention is not limited in its application to the details of the construction and arrangement of parts illustrated in the accompanying drawings. The invention is capable of other embodiments and of being practiced or carried out in a variety of ways. It is to be understood that the phraseology and terminology employed herein are for the purpose of description and not of limitation.

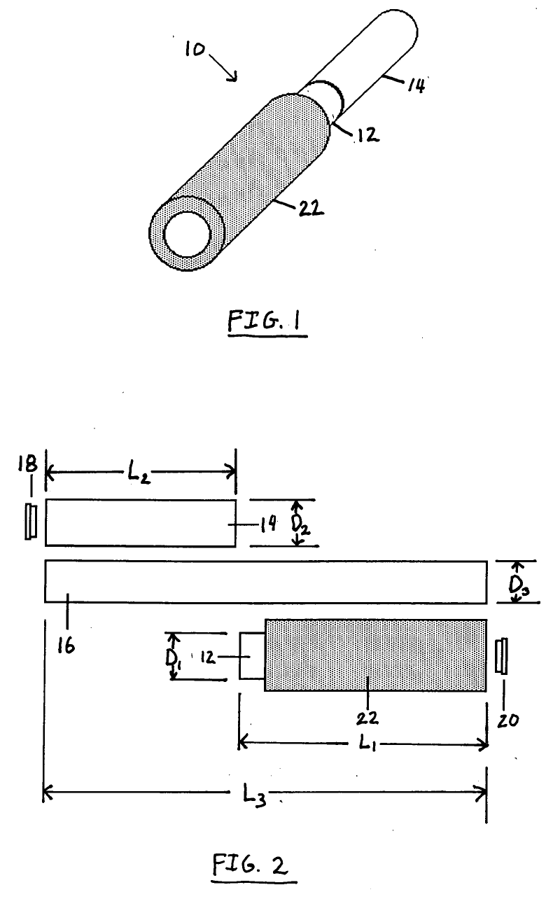

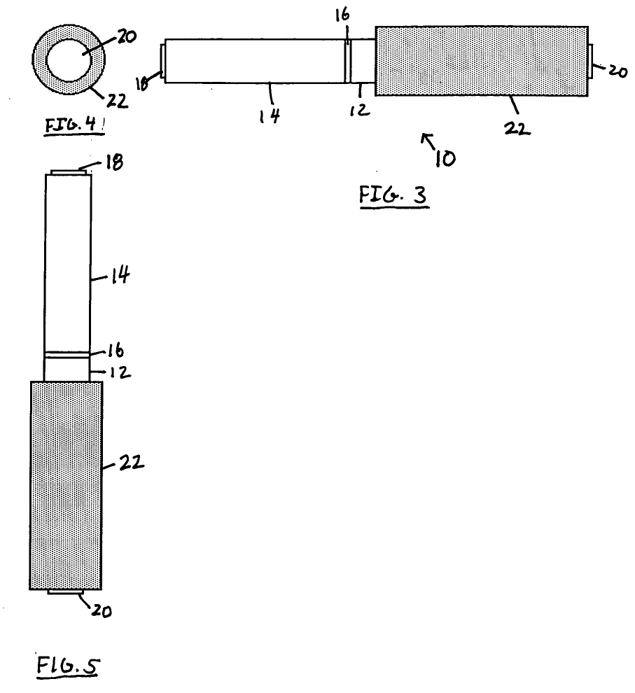

As shown in FIGS. 1-5, an embodiment 10 of the inventive apparatus to support multi-use film is illustrated. Embodiment 10 discloses a first outer tube 12, a second outer tube 14 and an inner cylinder 16. First outer tube 12 has a first diameter, D1, and a first length, L1. Second outer tube 14 has a second diameter, D2, and a second length, L2. Inner cylinder 16 has a diameter, D3, and a length, L3. The tubes 12 and 14 along with the inner cylinder 16 can be made from many different materials, including plastic and/or cardboard.

The diameter, D3, of the inner cylinder 16 is smaller than the diameters of the outer tubes, D1 and D2, such that the inner cylinder 16 can be slidably inserted into the outer tubes, 12 and 14. This allows the outer tubes 12 and 14 to independently rotate about the inner cylinder 16. The outer tubes 12 and 14 are secured to the inner cylinder 16 via end covers 18 and 20. The multi-use film 22 is rolled up over the surface of first outer tube 12. A user holds the second outer tube 14 to apply the multi-use film 22, which allows the first outer tube 12 to be able to spin freely about the inner cylinder 16.

The length L1 of first outer tube 12 can be equal to, larger or small than the length L2 of second outer tube. Further, length L3 of inner cylinder 16 can be longer than the length L1, L2 of the first outer tube 12 and/or second outer tube 14. Further, first diameter D1 of first outer tube 12 may or may not be equal to the second diameter D2 of second outer tube 14. Regarding first end cover 18 and second end cover 20, both can be identical and may or may not be slotted.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification.

1. An apparatus to support multi-use film comprising:
a first outer tube having a first diameter and a first length;
a second outer tube having a second diameter and a second length;
an inner cylinder having a third diameter and a third length, said third diameter being smaller than said first diameter and second diameter such that said inner cylinder can be slidably inserted into said first outer tube and said second outer tube can allowing said first outer tube and said second outer tube to rotate about said inner cylinder, with said first outer tube rotating independent of said second outer tube;
a first end cover removably secured to the outer end of said first outer tube; and
a second end cover removably secured to the outer end of said second outer tube,
wherein said multi-use film is rolled on said first outer tube.

2. The apparatus of claim 1 wherein said first length of said first outer tube is longer than said second length of said second outer tube.

3. The apparatus of claim 1 wherein said second length of said second outer tube is longer than said first length of said first outer tube.

4. The apparatus of claim 1 wherein said second length of said second outer tube is equal to said first length of said first outer tube.

5. The apparatus of claim 1 wherein said third length of said inner cylinder is longer than said first length of said first outer tube.

6. The apparatus of claim 1 wherein said third length of said inner cylinder is longer than said second length of said second outer tube.

7. The apparatus of claim 1 wherein said third length of said inner cylinder is shorter than the combined lengths of said second length of said second outer tube and said first length of said first outer tube.

8. The apparatus of claim 1 wherein said first end cover is identical to said second end cover.

9. The apparatus of claim 1 wherein said first diameter of said first outer tube is equal to said second diameter of said second outer tube.
